(19) United States
(12) Patent Application Publication
(10) Pub. No.: US 2020/0025297 A1
(43) Pub. Date: Jan. 23, 2020

(54) WATER CONTROL VALVE

(71) Applicant: Hung-Lin LAI, Changhua (TW)

(72) Inventor: Hung-Lin LAI, Changhua (TW)

(73) Assignee: WEN SHENG FU CO., LTD., Changhua (TW)

(21) Appl. No.: 16/038,165

(22) Filed: Jul. 17, 2018

(51) Int. Cl. F16K 5/04; F16K 31/60

(52) U.S. Cl. CPC F16K 5/0485; F16K 5/0442; F16K 31/60; F16K 5/0492; F16K 5/0464

(57) ABSTRACT

A water control valve may comprise a main body, a valve core, a sealing unit and a handle. The main body has a valve chamber to accommodate the valve core, and a first tube portion and a second tube portion are respectively extended from two sides of the valve chamber. The main body has a protruding portion formed at an outer periphery thereof, and a first through hole is adapted to vertically penetrate through the protruding portion to communicate with the valve chamber. The sealing unit is formed integrally to have a connecting portion, and a flexible sealer is formed at the outer periphery of the connecting portion. In present invention, the weight of the water control valve is reduced and the sealing unit can be easily pressed into the first through hole, to limit the position of the valve core and achieve the sealing effect.

### FIELD OF THE INVENTION

The present invention relates to a valve and more particularly to a water control valve.

### BACKGROUND OF THE INVENTION

Generally, referring to FIG. 9, a conventional water control valve (50) comprises a main body (51), a valve core (52), a locking nut (53) and a handle (54). The main body (51) has a valve chamber (511) formed at a central portion thereof, and the valve chamber (511) is configured to accommodate the valve core (52). Moreover, a first tube portion (512) is extended from a side of the valve chamber (511) while a second tube portion (513) is extended from the other side of the valve chamber (511). Furthermore, the valve core (52) has a second through hole (521) laterally penetrating through the valve core (52), and the valve chamber (511), the first tube portion (512) and the second tube portion (513) are communicated. The valve core (52) in the valve chamber (511) are adapted to be driven by the handle (54) to have rotation, and the second through hole (521) is configured to be aligned or misaligned with the first tube portion (512) and the second tube portion (513) so as to enable the flow from the first tube portion (512) to pass through or be blocked by the valve core (52). Additionally, the main body (51) has a protruding portion (514) formed at an outer periphery thereof, and a first through hole (515) is adapted to vertically penetrate through the protruding portion (514) to communicate with the valve chamber (511). The valve core (52) is adapted to be put into the valve chamber (511) through the first through hole (515), and a valve rod (552) extending from a top surface of the valve core (52) is configured to pass through the first through hole (515) to stick out of the valve chamber (511). A locking nut (53) is screwed on the valve rod (522) to couple with the protruding portion (514), and a handle (54) is connected to the valve core (52) through the valve rod (522). Also, a plurality of O-rings (55) are disposed on an outer periphery of the valve core (52) at positions avoiding the second through hole (521).

However, the conventional water control valve is disadvantageous because: (i) the locking nut (53) is made of metal which is heavy and high-cost; (ii) the processing of screwing the locking nut (53) down to the protruding portion (514) is troublesome and inefficient. Therefore, there remains a need for a new and improved design for a water control valve to overcome the problems presented above.

### SUMMARY OF THE INVENTION

The present invention provides a water control valve which comprises a main body, a valve core, a sealing unit and a handle. The main body has a valve chamber which is configured to accommodate the valve core, and a first tube portion is extended from a first side of the valve chamber while a second tube portion is extended from the other side thereof opposed to the first side. Also, the valve chamber, the first tube portion and the second tube portion are communicated, and the valve core has a second through hole laterally penetrating therethrough. The valve core in the valve chamber is configured to be driven by the handle to have rotation, and the second through hole is configured to be aligned or misaligned with the first tube portion and the second tube portion so as to enable the flow from the first tube portion to pass through or be blocked by the valve core. Additionally, the main body has a protruding portion formed at an outer periphery thereof, and a first through hole is adapted to vertically penetrate through the protruding portion to communicate with the valve chamber. The valve core is adapted to be put into the valve chamber through the first through hole, and a valve rod extending from a top surface of the valve core is configured to pass through the first through hole to stick out of the valve chamber. Moreover, the sealing unit is disposed on the valve rod, and the handle is connected to the valve rod thereafter. Furthermore, at least a sealing ring is disposed on an outer periphery of the valve core, and a locating groove is formed on an inner periphery of the first through hole. The sealing unit is formed integrally to have a connecting portion, and a stepped edge and a peripheral groove are respectively formed at an inner periphery and an outer periphery of the connecting portion. In addition, the stepped edge is configured to receive at least a first O-ring while at least a second O-ring is disposed on the peripheral groove so as to prevent the flow leaking from the inner and outer periphery of the sealing unit. Also, an inverted-truncated-cone-shaped sealer, which is flexible, is also formed at the outer periphery of the connecting portion so as to enable the sealing unit to be easily pressed into the first through hole. Moreover, when the sealing unit is pressed into the first through hole, the flexible sealer is adapted to abut against the inner surface of the first through hole and moved downwardly until the sealer is firmly engaged with the locating groove such that the sealing unit is configured to limit the valve core in the valve chamber.

Comparing with conventional water control valve, the present invention is advantageous because: (i) the sealing unit is formed integrally so as to reduce the weight of the water control valve and eliminate the trouble of additional processing; (ii) with the flexible sealer, the sealing unit can be easily pressed into the first through hole to limit the position of the valve core and achieve the sealing effect; and (iii) with the sealing unit, the assembly of the water control valve is simplified, and the manufacturing cost of the water control valve is also reduced.

### BRIEF DESCRIPTION OF THE DRAWINGS

FIG. 1 is a three-dimensional assembly view of a water control valve of the present invention.

FIG. 2 is a three-dimensional exploded view of the water control valve of the present invention.

FIG. 3 is a sectional exploded view of the water control valve of the present invention.

FIG. 4 is a partial enlarged drawing of FIG. 3 illustrating a sealing unit of the water control valve is disposed into a first through hole of the water control valve in the present invention.

FIG. 5 is another partial enlarged drawing of FIG. 3 illustrating the sealing unit is firmly coupled with a main body of the water control valve in the present invention.

FIG. 6 is a sectional assembly view of the water control valve of the present invention.

FIG. 7 is a schematic view illustrating the water control valve of the present invention is turned off.

FIG. 8 is a schematic view illustrating the water control valve of the present invention is turned on.

FIG. 9 is a prior art.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

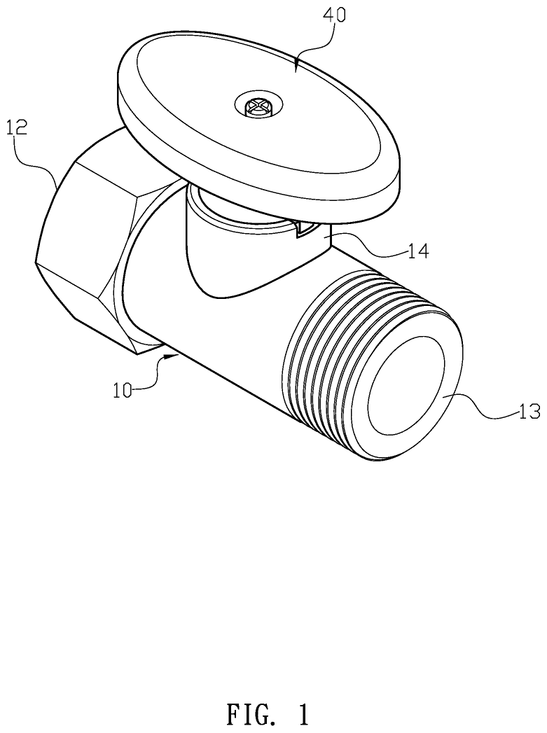

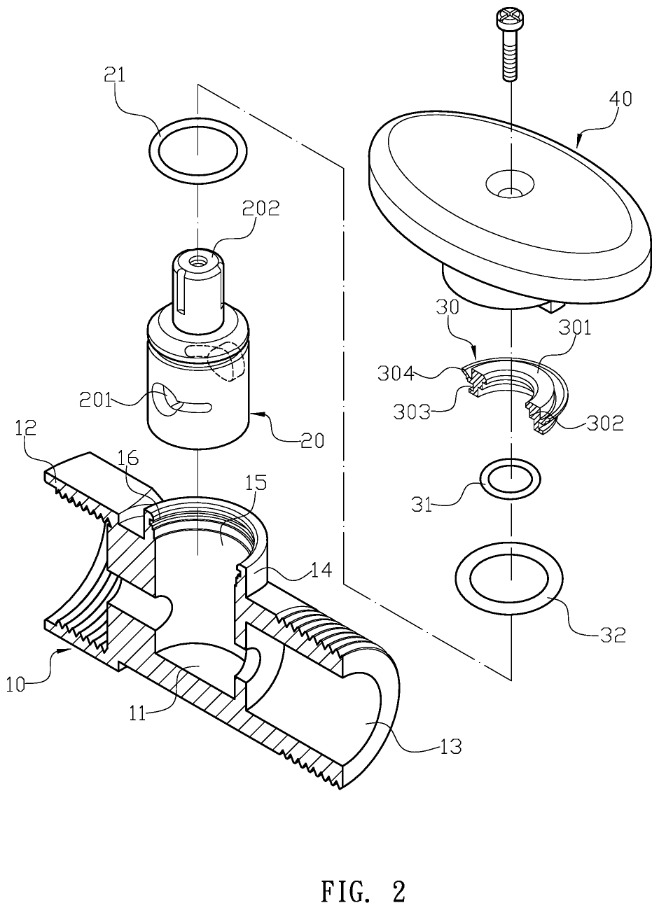

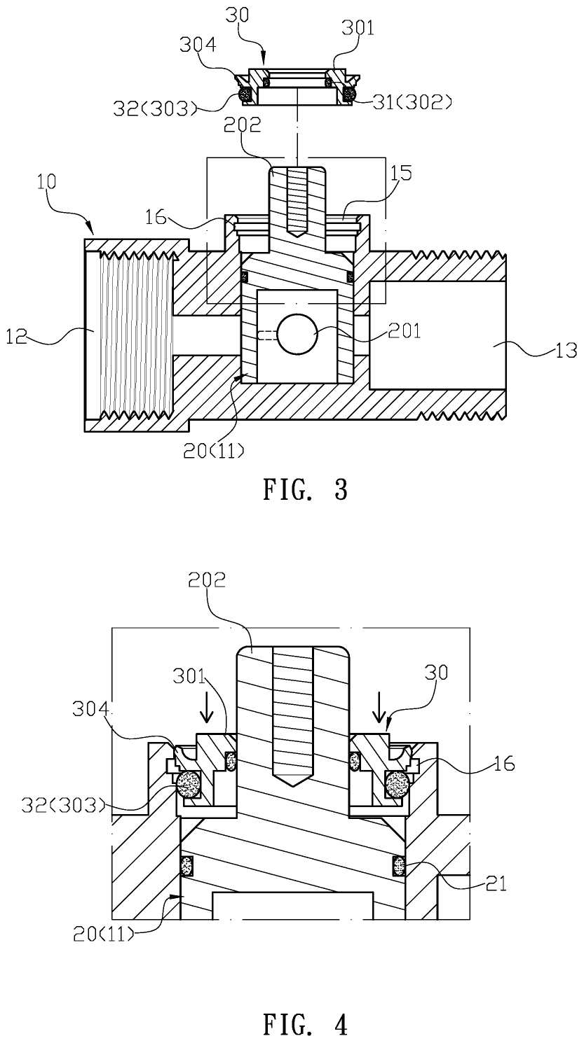

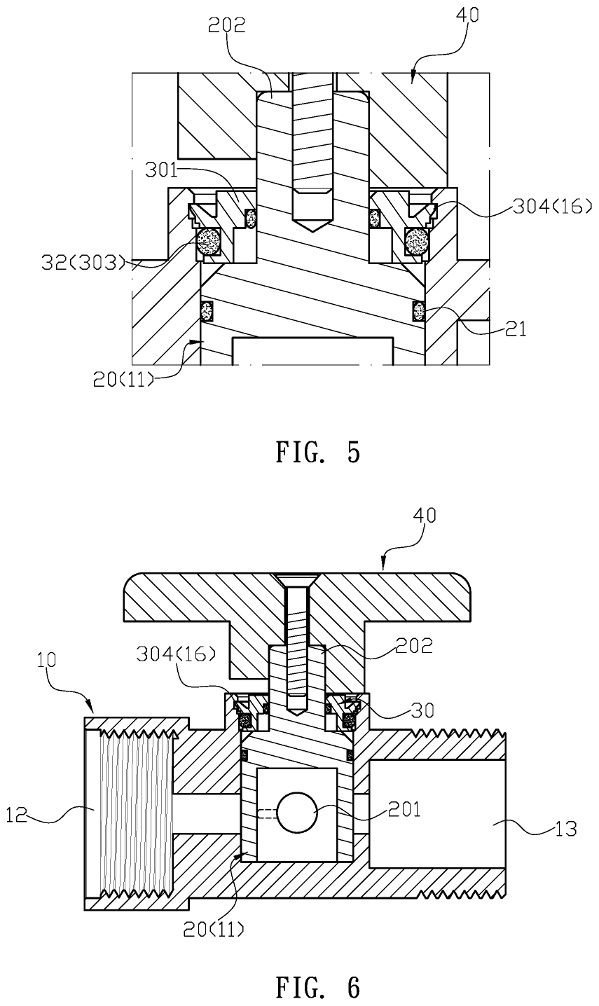

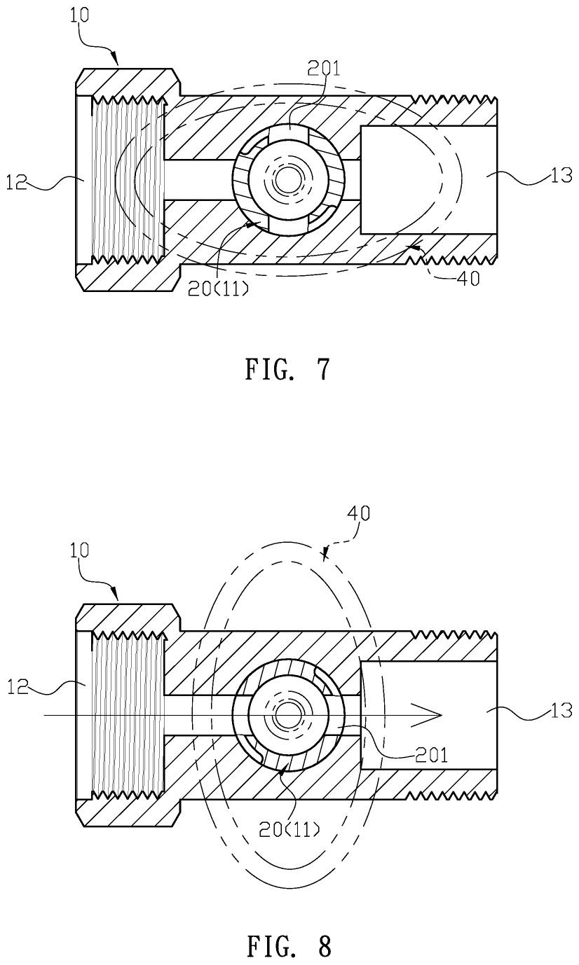

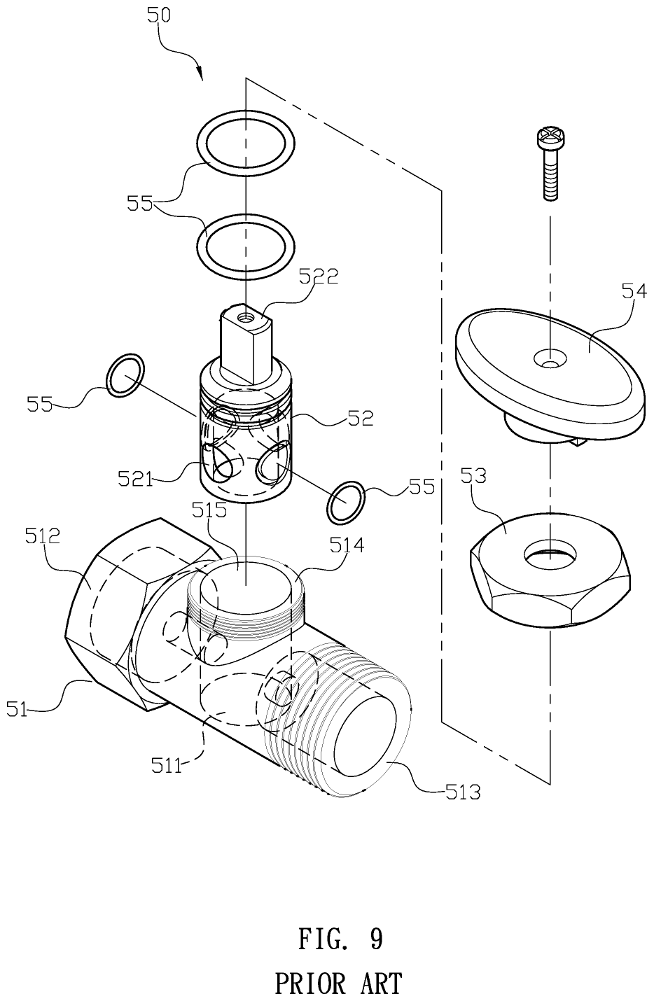

Referring to FIGS. 1 to 6, the present invention provides a water control valve which comprises a main body (10), a valve core (20), a sealing unit (30) and a handle (40). The main body (10) has a valve chamber (11) which is configured to accommodate the valve core (20), and a first tube portion (12) is extended from a first side of the valve chamber (11) while a second tube portion (13) is extended from the other side thereof opposed to the first side. Also, the valve chamber (11), the first tube portion (12) and the second tube portion (13) are communicated, and the valve core (20) has a second through hole (201) laterally penetrating therethrough. The valve core (20) in the valve chamber (11) is configured to be driven by the handle (40) to have rotation, and the second through hole (201) is configured to be aligned or misaligned with the first tube portion (12) and the second tube portion (13) so as to enable the flow from the first tube portion (12) to pass through or be blocked by the valve core (20) (as shown in FIGS. 7 and 8). Additionally, the main body (10) has a protruding portion (14) formed at an outer periphery thereof, and a first through hole (15) is adapted to vertically penetrate through the protruding portion (14) to communicate with the valve chamber (11). The valve core (20) is adapted to be put into the valve chamber (11) through the first through hole (15), and a valve rod (202) extending from a top surface of the valve core (20) is configured to pass through the first through hole (15) to stick out of the valve chamber (11). Moreover, the sealing unit (30) is disposed on the valve rod (202), and the handle (40) is connected to the valve rod (202) thereafter. Furthermore, at least a sealing ring (21) is disposed on an outer periphery of the valve core (20), and a locating groove (16) is formed on an inner periphery of the first through hole (15). The sealing unit (30) is formed integrally to have a connecting portion (301), and a stepped edge (302) and a peripheral groove (303) are respectively formed at an inner periphery and an outer periphery of the connecting portion (301). In addition, the stepped edge (302) is configured to receive at least a first O-ring (31) while at least a second O-ring (32) is disposed on the peripheral groove (303) so as to prevent the flow leaking from the inner and outer periphery of the sealing unit (30). Also, an inverted-truncated-cone-shaped sealer (304), which is flexible, is also formed at the outer periphery of the connecting portion (301) so as to enable the sealing unit (30) to be easily pressed into the first through hole (15). Moreover, when the sealing unit (30) is pressed into the first through hole (15), the flexible sealer (304) is adapted to abut against the inner surface of the first through hole (15) and moved downwardly until the sealer (304) is firmly engaged with the locating groove (16) such that the sealing unit (30) is configured to limit the valve core (20) in the valve chamber (11).

In one embodiment, the sealer (304) is connected to a top edge of the peripheral groove (303).

Comparing with conventional water control valve, the present invention is advantageous because: (i) the sealing unit (30) is formed integrally so as to reduce the weight of the water control valve and eliminate the trouble of additional processing; (ii) with the flexible sealer (304), the sealing unit (30) can be easily pressed into the first through hole (15) to limit the position of the valve core (20) and achieve the sealing effect; and (iii) with the sealing unit (30), the assembly of the water control valve is simplified, and the manufacturing cost of the water control valve is also reduced.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A water control valve comprising a main body, a valve core, a sealing unit and a handle,
wherein the main body has a valve chamber which is configured to accommodate the valve core, and a first tube portion is extended from a first side of the valve chamber while a second tube portion is extended from the other side thereof opposed to the first side; the valve chamber, the first tube portion and the second tube portion are communicated, and the valve core has a second through hole laterally penetrating therethrough; the valve core in the valve chamber is configured to be driven by the handle to have rotation, and the second through hole is configured to be aligned or misaligned with the first tube portion and the second tube portion so as to enable water inflow passes through or be blocked by the valve core; the main body has a protruding portion formed at an outer periphery thereof, and a first through hole is adapted to vertically penetrate through the protruding portion to communicate with the valve chamber; the valve core is adapted to be put into the valve chamber through the first through hole, and a valve rod extending from a top surface of the valve core is configured to pass through the first through hole to stick out of the valve chamber; the sealing unit is disposed on the valve rod, and the handle is connected to the valve rod; and
wherein a locating groove is formed on an inner periphery of the first through hole; the sealing unit is formed integrally to have a connecting portion, and a stepped edge and a peripheral groove are respectively formed at an inner periphery and an outer periphery of the connecting portion; the stepped edge is configured to receive at least a first O-ring while at least a second O-ring is disposed on the peripheral groove so as to prevent the flow leaking from the inner and outer periphery of the sealing unit; an inverted-truncated-cone-shaped sealer, which is flexible, is formed at the outer periphery of the connecting portion so as to enable the sealing unit to be easily pressed into the first through hole; when the sealing unit is pressed into the first through hole, the flexible sealer is adapted to abut against the inner surface of the first through hole and moved downwardly until the sealer is firmly engaged with the locating groove such that the sealing unit is configured to limit the valve core in the valve chamber.

2. The water control valve of claim 1, wherein the water inflow flows from the first tube portion into the main body.

3. The water control valve of claim 1, wherein at least a sealing ring is disposed on an outer periphery of the valve core.

4. The water control valve of claim 1, wherein the sealer is connected to a top edge of the peripheral groove.
